(19) United States
(12) Patent Application Publication
(10) Pub. No.: US 2009/0083197 A1
(43) Pub. Date: Mar. 26, 2009

(54) PROPERTY INVESTMENT INSTRUMENT, SYSTEM, METHOD, PRODUCT, AND APPARATUS

(76) Inventors: Uri Gofman, Cleveland, OH (US); Eric Schneider, Cleveland, OH (US)

Correspondence Address: ERIC SCHNEIDER, 1730 SOUTH FEDERAL HWY, #104, DELRAY BEACH, FL, 33483, US

(21) Appl. No.: 10/708,440

(22) Filed: Mar. 3, 2004

Related U.S. Application Data
(60) Provisional application No. 60/319,993, filed on Mar. 5, 2003.

(51) Int. Cl. G06Q 40/00

(52) U.S. Cl. 705/36 T; 705/35; 705/37; 705/38; 705/36 R

(57) ABSTRACT

A property investment instrument for investing in a property includes at least one contractual agreement between a first entity and a second entity to share in the property, the property having a plurality of investment components including a credit investment component and at least one of a capital investment component, knowledge investment component, time investment component, and labor investment component where the second entity can provide only the credit investment component and the first entity can provide at least one of the remaining investment components.

### CROSS REFERENCE TO RELATED APPLICATIONS

This application claims the benefit of U.S. Provisional Patent Application No. 60/319,993 by Gofman, et al., filed Mar. 5, 2003.

### BACKGROUND OF INVENTION

1. Document Disclosure Program

The application for patent is based on a disclosure filed on Oct. 30, 2002, as Disclosure Document No. 520,821 under the Document Disclosure Program

2. Field of the Invention

This invention generally relates to property investments, and more specifically relates to a property investment instrument, system, method, product, and apparatus.

3. Description of the Related Art

The ability to generate revenue and provide a return on investment usually requires the risk and use of resources such as money, time, knowledge, and labor. Investors generally desire investments that provide a safe, steady income stream. Such investors also desire liquidity, so that their investment interests can easily be sold or rearranged. Additionally, investors generally do not want to actively manage their investments. Numerous attempts have been made to provide property investments that are transferable, have a steady income stream, require low management effort, and are divisible. One form of property investment that offers such benefits is a real estate investment trust (a “REIT”).

Congress created REITs in 1960 to enable small investors to make investments in large-scale, income-producing real estate. Congress decided that the only way for the average investor to access investments in significant commercial properties was through pooling arrangements. As a result, Congress designed REITs to unite the capital of many into a single economic enterprise. That enterprise is geared to the production of income through commercial real estate ownership and finance.

A REIT is a company that buys, sells, manages, and develops real estate or real estate mortgages on behalf of its investors. Shares in a REIT may be purchased, or acquired indirectly in exchange for property. These shares are often publicly traded on major exchanges, and have characteristics similar to the characteristics of shares in any other company. For example, the shares are easy to liquidate, and often provide a reasonably steady stream of income through dividends.

While the benefits of real estate investment are viable, there have traditionally been a number of barriers of entry in real estate investing. Unlike the stock market, where one can, based on an analyst's suggestions, acquire stock in a given company with a small investment of capital by simply writing a check, investment in real estate requires far more research and capital in order to be successful. In addition to having to acquire knowledge of the local real estate market, one would need to allocate a significant amount of time for the purpose of managing the investment after acquisition to insure success. This coupled with the fact that real estate investment requires, in most cases, a significant amount of investment capital, prevents most people from being able to participate in all of the benefits that this investment can offer.

Maximizing the rate of return on investment dollars is the goal of all investors. Banks and similar institutions in the real estate business maximize their return realizable on loans by, for example, lending money to customers to purchase property and charging interest for the loan at a rate above their borrowing cost. The loan instrument is often referred to as a promissory note that specifies a principal amount borrowed from the lender and an interest rate, and is secured by a mortgage or deed of trust on the property. The lender's rate of return corresponds to the interest rate.

Residential mortgage lending usually includes a two-fold evaluation of the loan repayment ability of prospective homeowners and mortgage applicants. This process encompasses payment affordability (e.g., the percentage of applicant income required to make monthly mortgage payments) and underlying collateral value in case of foreclosure and resale (e.g., Loan-To-Value ratios: the ratio of principal obligation to appraised house value). Together, these factors have formed the credit risk of mortgage lending.

Consumer loan products by mortgage companies can include traditional primary residence mortgage loans to consumers with good credit histories and loans to consumers who qualify under certain government-backed loan programs such as Federal Housing Administration (FHA) or the Veterans Administration (VA). There are various institutions that facilitate the movement of funds for the mortgage companies. These entities include Federal National Mortgage Association (“Fannie Mae”), Federal Home Loan Mortgage Corporation (“Freddie Mac”), and Government National Mortgage Association (“Ginnie Mae”). These institutions purchase or securitize loans originated by mortgage companies. These purchases or securitizations recycle funds back to the originating mortgage company, allowing them to make loans to additional homebuyers.

One criterion that is often considered by lenders making loans is the borrower's credit rating. A consumer's credit rating is an indication of their ability to pay outstanding debts. Credit rating companies, such as Trans Union Corporation, Experian, Inc., and Equifax, Inc., collect certain information on individual consumers and assign each a credit rating based on this information. One method of obtaining a credit rating is known as a “FICO score” which is based on a mathematical model developed by Fair, Isaac, and Company, Inc.

A FICO score is based on many factors including how a consumer pays their bills, outstanding debt, how long a consumer has had credit, types of credit a consumer has, and how many times a consumer has recently applied for or opened new lines of credit. Loans are typically made to people with relative high FICO scores, known as “A” borrowers. “A” borrowers have credit ratings which indicate that they will most likely be able to repay a loan.

One's credit rating, credential, or “good name” can be considered a quantifiable source for enabling an individual or entity to have a loan obtainment ability. This loan obtainment ability has been used as a source of leverage primarily among friends and family when two parties co-sign a loan. For example, a son may ask a father to use his credential or “good name” to co-sign on a loan that the son may not have been able to obtain solely by his own means with the understanding that the son will pledge and bear all of the responsibility associated with repaying the loan obligation.

Though the use and risk of money, time, knowledge, and labor resources can help generate revenue to provide a return on investment, the source of one's credential or “good name” has never before been used or systematically reused as an investment resource. Furthermore, there exists no known method for providing an investment instrument that enables a “credit investor” to invest in only a credit investment component of the instrument apart from all other investment components of the investment instrument.

In view of the foregoing, it would be desirable to provide new methods of investing in property that provide safety, a steady income stream, divisibility, ready liquidity, and no involvement in management of the property.

### SUMMARY OF INVENTION

The invention assists equity partners in sharing in a property investment having at least a credit investment component. The invention enables the partnering of an entity having a capital supply obtainment ability and an entity having a loan obtainment ability (a credit investor) to participate in an investment in one or more properties. The invention enables property sellers, property buyers, and credit investors to participate in the acquisition, sale and transfer of ownership of a property. A credit investor is typically an individual or entity that invests in a property by risking their credit, “good name”, creditability, credential, creditworthiness, credit rating, credit obtainment ability, mortgage obtainment ability, or loan obtainment ability. Such a credit investor typically does not additionally invest any capital, knowledge, or labor related components.

The invention can assist in the list generation of properties that could be available for acquisition including discovering leads from network resources via a search agent and/or receiving leads/solicitations from property brokers and property owners. The invention can assist in qualifying each property from the generated list based on at least one criteria including at least one of a purchase formula and operations formula, the formulas including one or more variables such as rental price, usage factor, management fee, maintenance fee, property expense, utility expense, principal payment, interest payment, tax payment, insurance payment, loan-to-value ratio, down payment amount, appraisal value, sale price, and cost of initial construction.

The invention can assist in the list generation of individuals having interest in participating as a credit investor in a credit investment opportunity including receiving leads/solicitations from employers, financial planners, investment professionals, real estate brokers, lenders, credit and labor unions. The invention can assist in qualifying each credit investor from the generated list based on at least one criterion including criteria such as employment history, credit rating, etc.

The invention enables a credit investor to access a current report indicative of the financial health of any property-related credit investment. The invention can assist in presenting to a requestor, a credit report having a minimum credit rating value with the option to learn more about a credit investment opportunity.

In general, in accordance with the invention, a property investment instrument for investing in a property includes at least one contractual agreement between a first entity and a second entity to share in the property, the property having a plurality of investment components including a credit investment component and at least one of a capital investment component, knowledge investment component, time investment component, and labor investment component wherein the second entity provides the credit investment component and the first entity provides at least one of the remaining components of the plurality of investment components.

In accordance with an aspect of the invention, a method for creating a property investment instrument includes acquiring a property having a plurality of investment components including a credit investment component and at least one of a capital investment component, knowledge investment component, time investment component, and labor investment component, and encumbering the property with at least one contractual agreement between a first entity and a second entity wherein the second entity agrees to provide the credit investment component and the first entity agrees to provide at least one of the remaining components of the plurality of investment components.

In accordance with another aspect of the invention, a method for a first entity and a second entity investing in a property includes the first entity obtaining a first amount of capital for an owner of the property in exchange for transferring title of the property to the second entity, the second entity having at least one of a loan obtainment ability, mortgage obtainment ability, and credit obtainment ability, the second entity obtaining a loan for a second amount of capital from a lender by using said property as collateral wherein the loan includes a loan obligation to repay the lender, and the second entity transferring at least a portion of said second amount of capital to said first entity.

In accordance with yet another aspect of the invention, a method for providing information to a recipient includes retrieving a credit report corresponding to an entity, retrieving educational material adapted to teach how the entity can participate in a property investment having a plurality of investment components including a credit investment component wherein the entity can participate by agreeing to be responsible for only the credit investment component of the property investment, generating the information by combining the educational material with the credit report corresponding to the entity, and providing the generated information to the recipient.

In accordance with an aspect of the invention, a method for providing information to a recipient includes retrieving a first material including at least one of a financial planning type information and retirement planning type information, retrieving a second material including an educational material adapted to teach how an entity can participate in a property investment having a plurality of investment components including a credit investment component wherein the entity can participate by agreeing to be responsible for only the credit investment component of the property investment, generating the information by combining the first material with the second material, and providing the generated information to the recipient.

In accordance with another aspect of the invention, a method includes a first entity acquiring a property from an owner of the property by supplying a first amount of capital to the owner, transferring title of the property to a second entity having a loan obtainment ability, the second entity obtaining a loan for a second amount of capital from a lender by using the property as collateral wherein the loan includes a loan obligation to repay the lender, and the second entity transferring at least a portion of at least one of a loan obligation, title, property, and second amount of capital to at least one of a first entity and third entity.

In accordance with additional aspects of the invention, a system and/or device implements substantially the same functionality in substantially the same manner as the methods described above.

In accordance with other additional aspects of the invention, a computer-readable medium that includes computer-executable instructions may be used to perform substantially the same methods as those described above.

The foregoing and other features of the invention are hereinafter fully described and particularly pointed out in the claims. The following description and the annexed drawings set forth in detail one or more illustrative aspects of the invention, such being indicative, however, of but one or a few of the various ways in which the principles of the invention may be employed.

### BRIEF DESCRIPTION OF DRAWINGS

FIG. 1a is a block diagram illustrating an exemplary distributed computer system in accordance with the invention.

FIG. 1b is a block diagram illustrating exemplary information records stored in memory in accordance with the invention.

FIG. 2a is a block diagram illustrating an exemplary property having investment components in accordance with the invention.

FIG. 2b is a block diagram illustrating an exemplary property investment system in accordance with the invention.

FIG. 2c is a block diagram illustrating the components of a property investment instrument in accordance with the invention.

FIG. 2d is a block diagram illustrating the components of a third entity in accordance with the invention.

FIG. 2e is a flowchart illustrating the steps of a method for acquiring and encumbering a property in accordance with the invention.

FIG. 2f is a flowchart illustrating the steps of a method for executing an agreement relating to a property in accordance with the invention.

FIG. 2g is a flowchart illustrating the steps of a method for executing additional agreements relating to a property in accordance with the invention.

FIG. 3a is a top-level flowchart illustrating the steps of a method for acquiring a property in accordance with the invention.

FIG. 3b is a flowchart illustrating the steps of a method for transferring a property title in accordance with the invention.

FIG. 3c is a flowchart illustrating the steps of a method for choosing a property for acquisition from a list of properties in accordance with the invention.

FIG. 3d is a flowchart illustrating the steps of a method for choosing a participating second entity in accordance with the invention.

FIG. 4a is a flowchart illustrating the steps of a method for requesting a current report indicative of financial health of a third entity in accordance with the invention.

FIG. 4b is a flowchart illustrating the steps of a method for establishing an agreement between a first entity and a property manager to manage at least one property in accordance with the invention.

FIG. 5a is a flowchart illustrating the steps of a method for investing in a property in accordance with the invention.

FIG. 5b is a flowchart illustrating the steps of a method for disposing of a property in accordance with the invention.

FIG. 6a is a flowchart illustrating the steps of a method for learning about a credit investment opportunity in accordance with the invention.

FIG. 6b is a flowchart illustrating the steps of a method for requesting a credit report in accordance with the invention.

FIG. 6c is a flowchart illustrating the steps of a method for providing generated information to a recipient in accordance with the invention.

FIG. 7a is a block diagram illustrating an exemplary property acquisition and credit investment management system in accordance with the invention.

FIG. 7b is a block diagram illustrating an exemplary property acquisition and management system in accordance with the invention.

FIG. 7c is a block diagram illustrating an exemplary property management affiliate system in accordance with the invention.

FIG. 8 is a block diagram illustrating exemplary related system user interfaces in accordance with the invention.

### DETAILED DESCRIPTION

The invention will now be described with reference to the drawings, wherein like reference numerals are used to refer to like elements throughout.

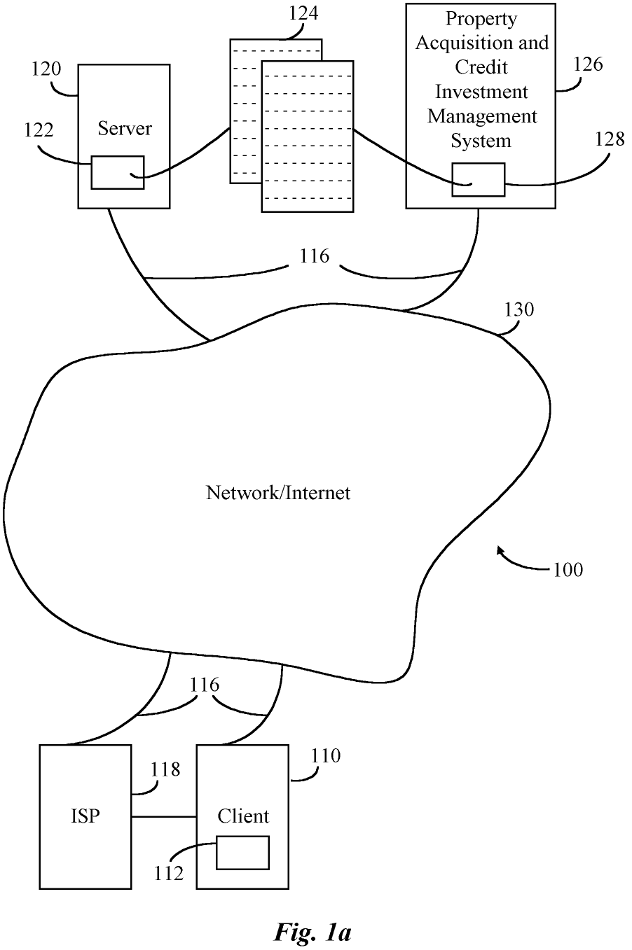

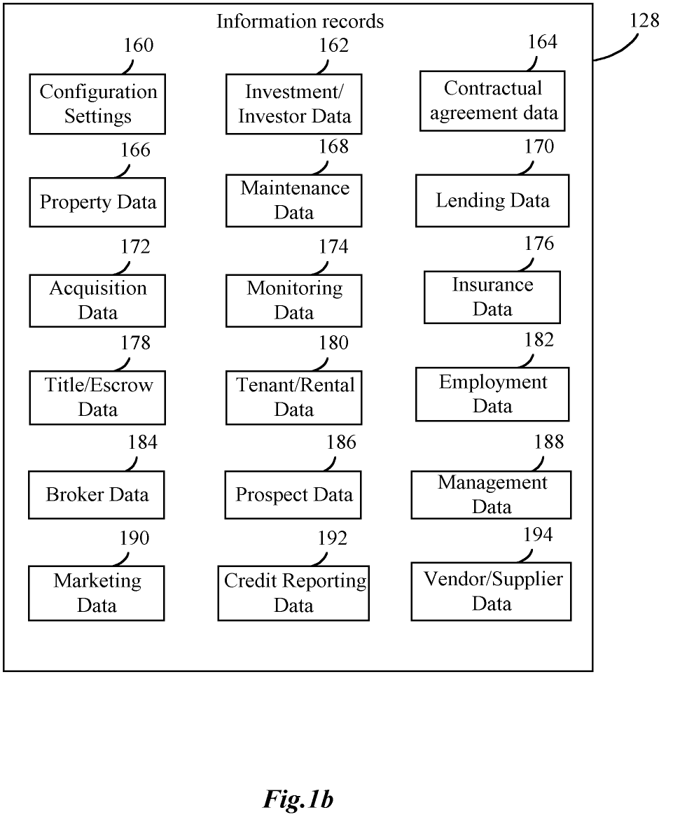

FIG. 1a is a block diagram illustrating an exemplary distributed computer system 100 in accordance with the invention. The distributed computer system 100 may include any number of client computers (client) or any such network access apparatus connected to server computers 120 (servers) via a network 130. The network 130 may use Internet Protocols (IP) to allow the clients 110 to communicate with the servers 120. The client 110 may include a modem or like transceiver to communicate via the network 130. The modem may communicate with the network 130 via a line 116 such as a telephone line, an ISDN line, a coaxial line, a cable television line, a fiber optic line, or a computer network line. Alternatively, the modem may wirelessly communicate with the network 130. The network 130 may be accessed via an on-line service, an Internet Service Provider (ISP) 118, a local area network service, a wide area network service, a cable television service, a wireless data service, an intranet, a virtual private network service, a peer-to-peer network service, a satellite service, or the like.

The client computers 110 may be any network access apparatus including hand held devices, palmtop computers, personal digital assistants (PDAs), notebook, laptop, portable computers, desktop PCs, workstations, and/or larger/smaller computer systems. It is noted that the client computers 110 may have a variety of forms, including but not limited to, a general purpose computer, a network computer, a network television, an internet television, a set top box, a web-enabled telephone, an internet appliance, a portable wireless device, a television receiver, a game player, a video recorder, and/or an audio component, for example.

Each client 110 typically includes one or more processors, memories, and input/output devices. An input device may be any suitable device for the user to give input to client computer 110, for example: a keyboard, a 10-key pad, a telephone key pad, a light pen or any pen pointing device, a touchscreen, a button, a dial, a joystick, a steering wheel, a foot pedal, a mouse, a trackball, an optical or magnetic recognition unit such as a bar code or magnetic swipe reader, a voice or speech recognition unit, a remote control attached via cable or wireless link to a game set, television, and/or cable box. A data glove, an eye tracking device, or any MIDI device may also be used. A display device may be any suitable output device, such as a display screen, text-to-speech converter, printer, plotter, fax, television set, or audio player. Although the input device is typically separate from the display device, they could be combined; for example: a display with an integrated touchscreen, a display with an integrated keyboard, or a speech-recognition unit combined with a text-to-speech converter.

The servers 120 may be similarly configured. However, in many instances server sites include many computers collectively referred to as the server 120, perhaps connected by a separate private network (not shown). In fact, the network 130 may include hundreds of thousands of individual networks of computers. Although the client computers 110 are shown separate from the server computers 120, it should be understood that a single computer may perform the client and server roles. Those skilled in the art will appreciate that the computer environment 100 shown in FIG. 1a is intended to be merely illustrative. The invention may also be practiced in other computing environments. For example, the invention may be practiced in multiple processor environments wherein the client computer 110 includes multiple processors. Moreover, the client computer 110 need not include all of the input/output devices as discussed above and may also include additional input/output devices. Those skilled in the art will appreciate that the invention may also be practiced via Intranets and more generally in distributed environments in which a client computer requests resources from a server computer.

During operation of the distributed system 100, users of the clients 110 may desire to access information records 122 stored by the servers 120 while utilizing, for example, the Web. Furthermore, such server systems 120 may also include one or more search engines having one or more databases. The records 122 may be in the form of Web pages 124. The Web pages 124 may be data records including as content plain textual information, or more complex digitally encoded multimedia content, such as software programs, graphics, audio signals, videos, and so forth. It should be understood that although this description focuses on locating information on the World-Wide-Web, the system may also be used for locating information via other wide or local area networks (WANs and LANs), or even information stored in a single computer using other communications protocols.

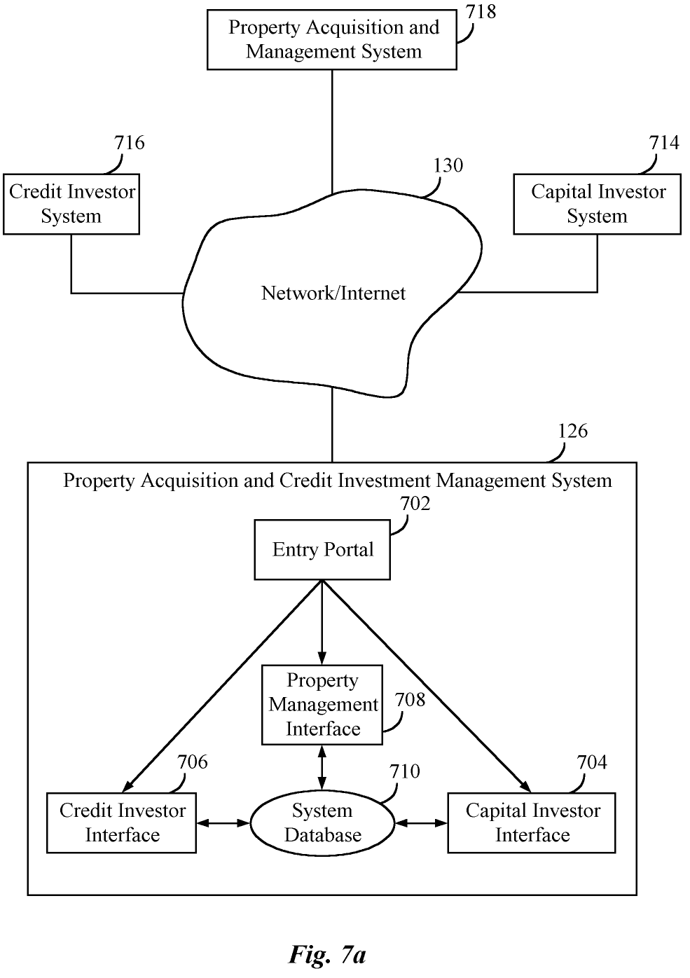

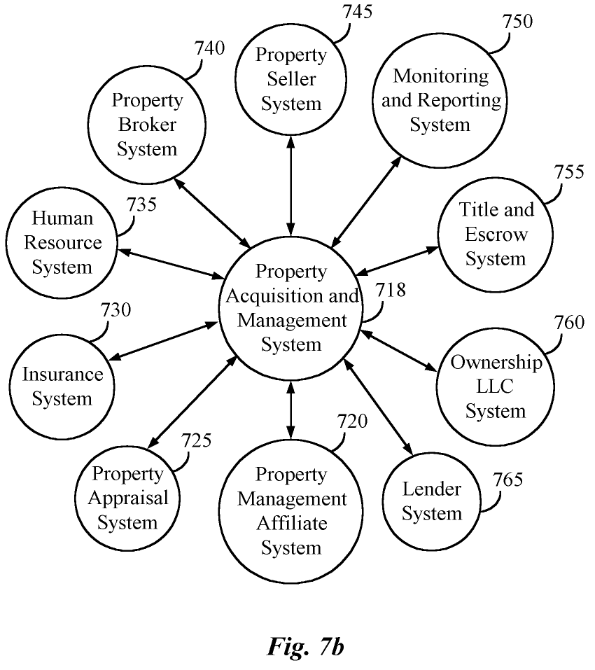

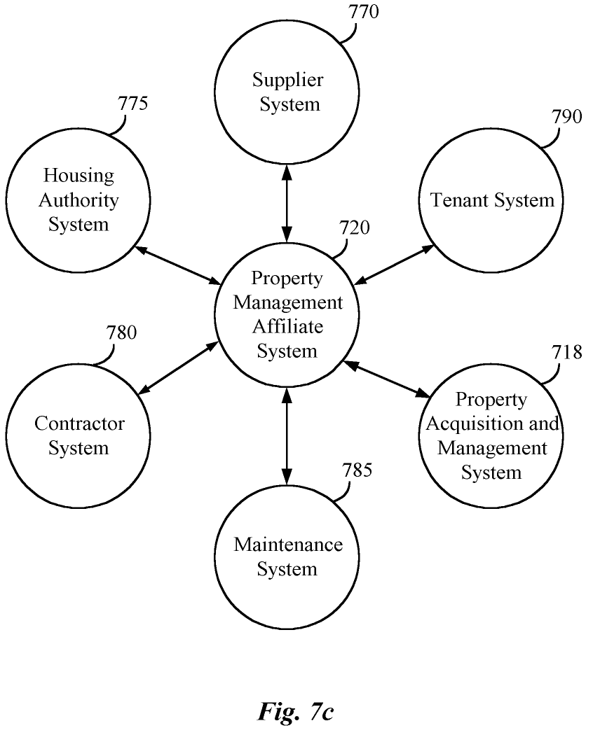

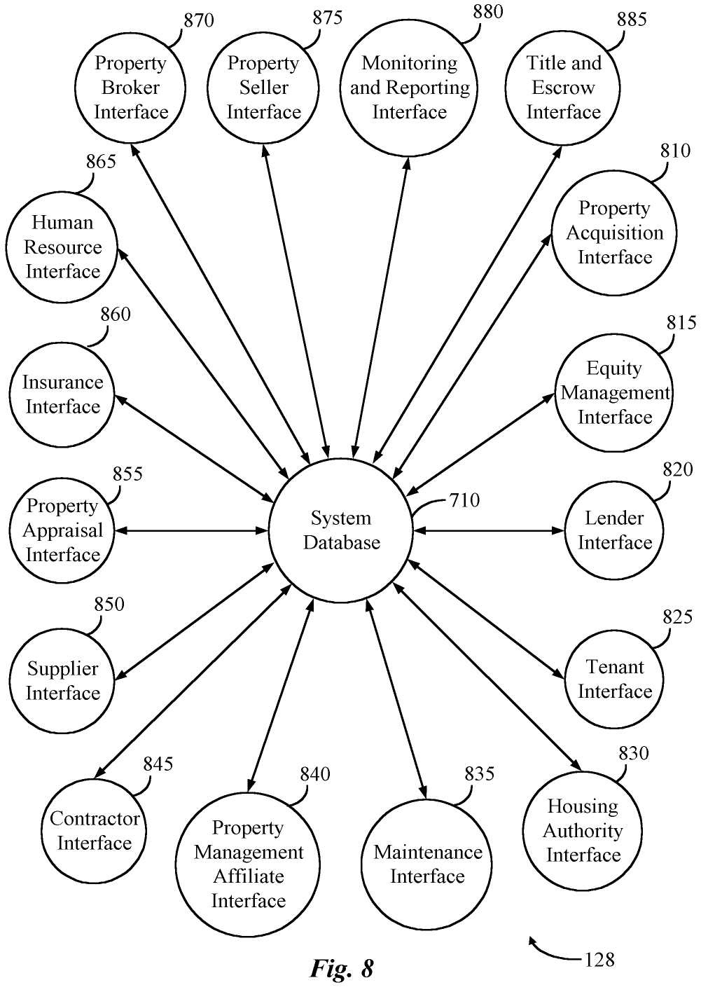

A property acquisition and credit investment management system 126 is a server (e.g., 120) that is specifically configured for use according to the invention. The inventive system 126 has one or more information records 128 that are property-related including special user interfaces, which may also be in the form of Web pages 124. The property acquisition and credit investment management system 126 is preferably implemented as a web-based portal system that can be accessed and used by property owners, property managers, credit investors, equity partners, and the like via the network 130 such as the Internet. Such a system will be further illustrated in more detail hereinbelow (see FIGS. 7a-7c, and FIG. 8).

The clients 110 may execute Web browser programs 112, such as Netscape Navigator or Microsoft Internet Explorer (MSIE) to locate the Web pages 124 or the records 128. The browser programs 112 enable users to enter addresses of specific Web pages 124 to be retrieved. Typically, the address of a Web page is specified as a Uniform Resource Identifier (URI) or more specifically as a Uniform Resource Locator (URL). In addition, when a page has been retrieved, the browser programs 112 may provide access to other pages or records by “clicking” on hyperlinks (or links) to other Web pages. Such links may provide an automated way to enter the URL of another page, and to retrieve that page.

FIG. 1b is a block diagram illustrating examples of the exemplary information records 128 that may be stored in the property acquisition and credit investment management system 126 in accordance with the invention. The system records 128 include any combination of exemplary content such as lists, files, and databases, but records important to many aspects of the invention include at least one of the following; configuration settings 160, investment/investor data 162, contractual agreement data 164, property data 166, maintenance data 168, lending data 170, acquisition data 172, monitoring data 174, insurance data 176, title/escrow data 178, tenant/rental data 180, employment data 182, broker data 184, prospect data 186, management data 188, marketing data 190, credit reporting data 192, and vendor/supplier data 194.

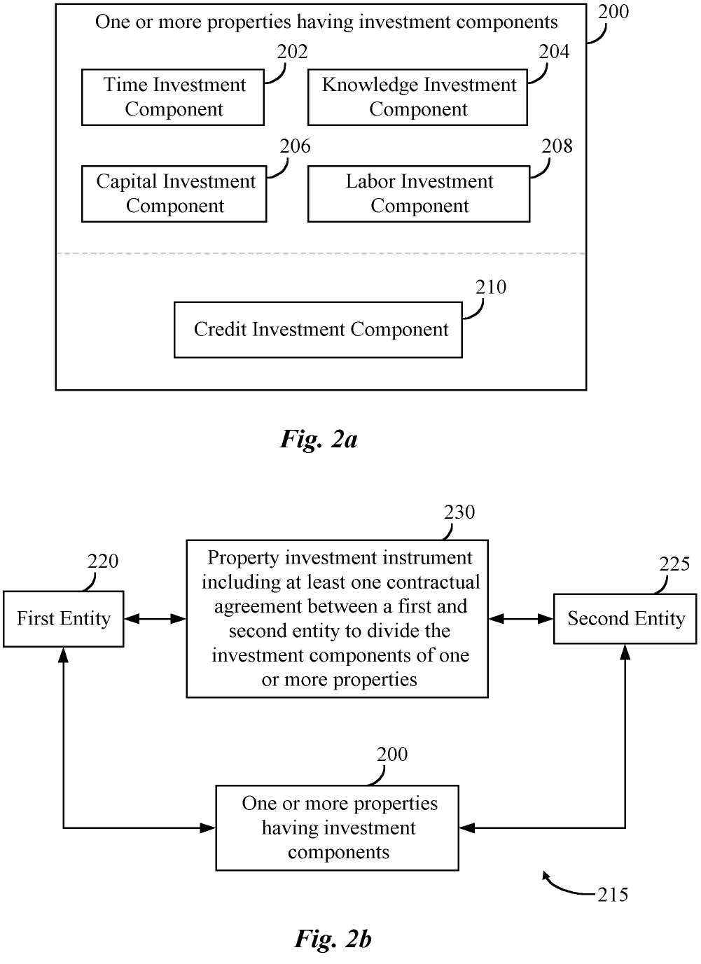

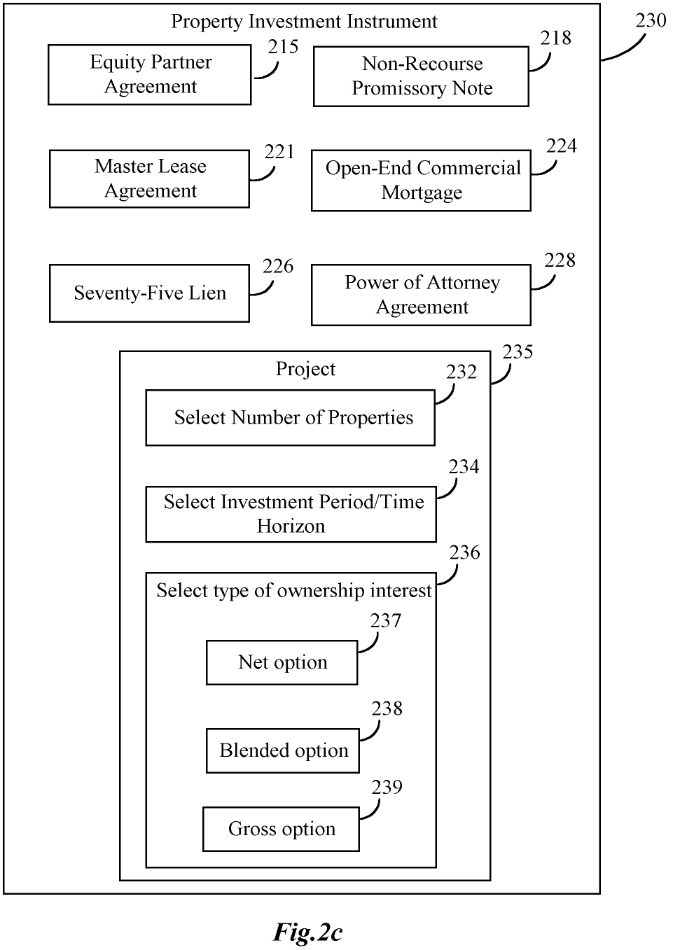

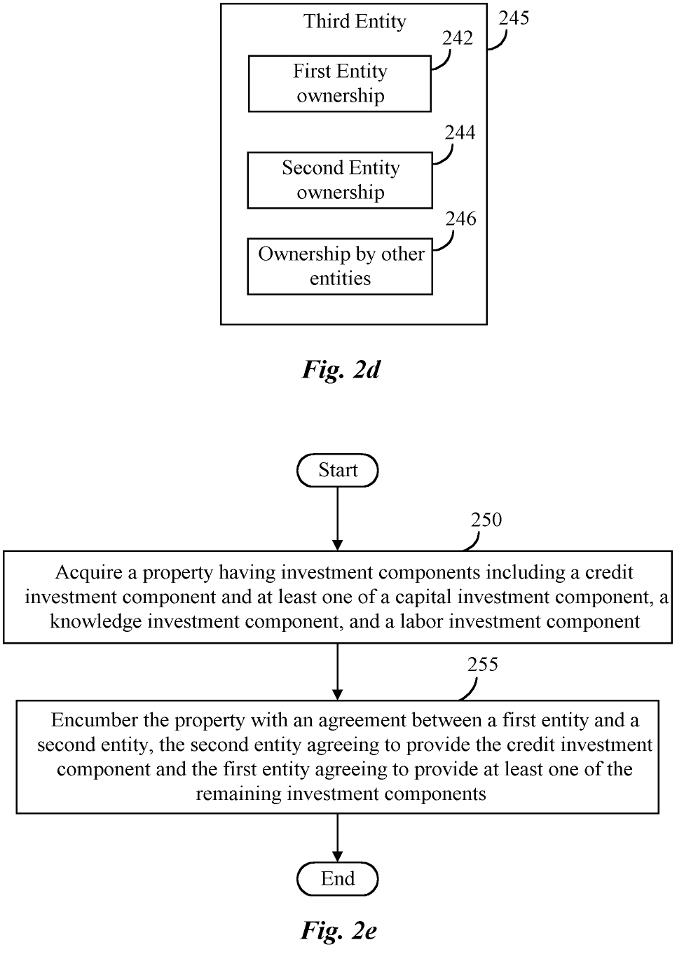

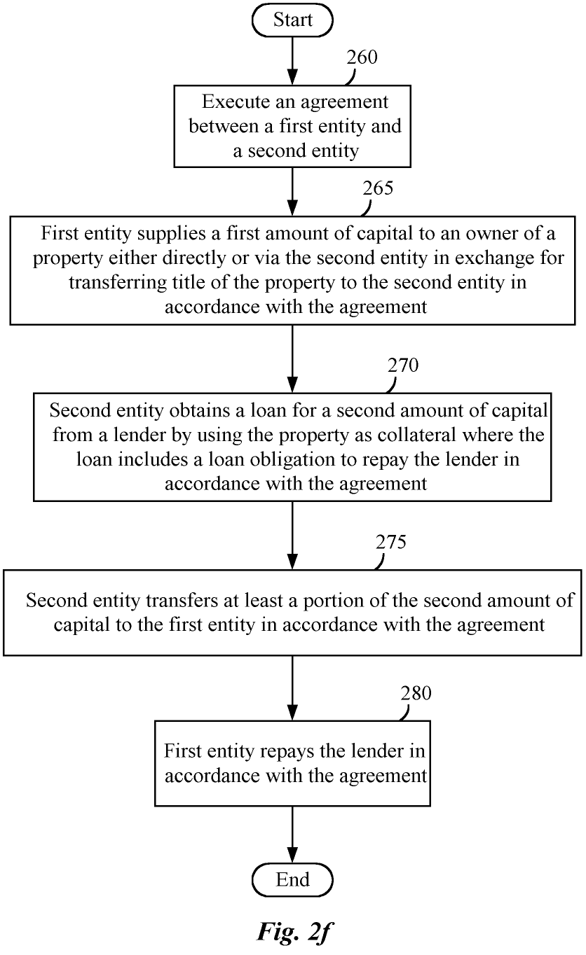

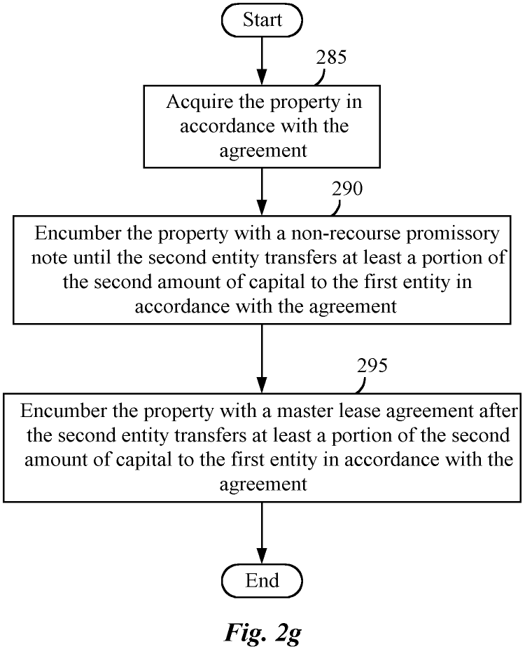

FIG. 2a is a block diagram illustrating an exemplary property having investment components in accordance with the invention. The property 200 includes a plurality of investment components including a credit investment component 210 and one or more additional components including a time investment component 202, knowledge investment component 204, capital investment component 206, and labor investment component 208. For example, a real property such as real estate can be one or more properties having investment components including at least one equity partner responsible for making such a property investment decision by providing the time 202 and knowledge 204 needed to select each property worthwhile of acquisition, to supply capital 206 to acquire the property, and to supply labor 208 to rehabilitate and maintain the property. Traditionally such an acquisition requires investments of money, time, knowledge and labor. However in accordance with an aspect of the invention, such a property 200 can further include a credit investment component 210. For instance, an investment approach can now be enabled to contractually isolate and leverage the credit investment component 210 of a property 200 by investing one's credit obtainment ability to assist in obtaining traditional long term mortgage financing on a real property by using the property as collateral.

FIG. 2b is a block diagram illustrating an exemplary property investment system that employs a property investment instrument in accordance with the invention. Such a property investment system 215 can be implemented in a relationship between at least two parties such as a first entity 220 and a second entity 225. For example, with a one or more properties 200 having investment components including a credit investment component 210 and one or more components including a time investment component 202, knowledge investment component 204, capital investment component 206, and labor investment component 208, the property investment instrument in the form of one or more contractual agreements 230 can be arranged and signed between a first entity 220 and a second entity 225 to divide the investment components of each property 200 such that the second entity 225 need be responsible for at least the credit investment component 210 and the first entity 220 responsible for at least one of the remaining investment components (e.g., 202, 204, 206, 208) needed to grow the investment of each acquired property.

FIG. 2c is a block diagram illustrating the components of a property investment instrument in accordance with the invention. As shown in FIG. 2b, the property investment instrument 230 can take the form of one or more contractual agreements. These agreements can include an equity partner agreement 215, a non-recourse promissory note 218, a master lease agreement 221, an open-end commercial mortgage 224, a seventy-five lien 226 (typically in the form of one or more promissory notes), a power of attorney agreement 228. The property investment instrument 230 also defines the scope of the project 235 between the first entity 220 and the second entity 225. The second entity 225 is typically responsible for defining project 235 parameters including selecting the number of properties 232, selecting the investment period/time horizon 234, and selecting the type of ownership interest 236 including selecting a net option 237, blended option 238, or gross option 239. These property investment instrument components will be shown in more detail hereinbelow.

FIG. 2d is a block diagram illustrating the components of a third entity in accordance with the invention. A third entity 245 such as a company or organization can be created such that both the first entity 220 has a first ownership interest 242 and the second entity 225 has a second ownership interest 244 in the third entity 245. There can also be ownership interest of other entities 246 in the third entity 245 as well.

Similarly, such a property investment system 215 (see FIG. 2b) can be structured to allow additional entities to participate and manage other aspects of a property's investment components as well. The third entity 245 can also participate in the property investment system 215 by agreeing to the one or more contractual agreements 230 such that the third entity 245 realizes the benefits of revenue generated from the property 200 including all proceeds after the sale or disposition of such property 200. The second entity 225 typically owns between a 20% and 25% share of the third entity 245 in exchange for providing the credit investment component 210 by investing/risking one's credential or “good name” as part of the property investment system 215.

For example, two entities (e.g., 220, 225) can cooperate in a property investment wherein a first entity 220 can provide the knowledge and experience (knowledge investment component 204) of the real estate market, the capital to be used in acquisition and stabilization of the property (capital investment component 206), the network of lenders and professionals instrumental in the acquisition and ownership stage of the investment, the systems and experience in property management, and the like, which can minimize the investment of a second entity 225 that can participate in the property investment as an equity partner by risking only a credit rating via using one's credit obtainment or mortgage obtainment ability (credit investment component 210) for qualifying for and obtaining mortgages 224 secured by the investment property 200.

The contractual agreement 230 between the first entity 220 and the second entity 225 serves as an instrument for leveraging the credit investment component 210 of one or more property related investments 200. For example, the first entity 220 and the second entity 225 can agree to engage in the venture of developing real property acquisitions through their joint efforts for mutual gain by forming a third entity 245 such as a jointly owned business, having limited liability. The first entity 220 and second entity 225 can agree that a goal of the business shall be to identify, acquire and operate between one and eight (e.g. 232), one-family to four-family dwelling units with a view to maximizing wealth and profit over the term of the business relationship. For instance, the second entity 225 shall have the right to select the investment horizon from a choice provided by the first entity 220 of (10, 15, 20, 25, or 30 years) for the second entity's participation in ownership of the project 235 thereby defining the time horizon 234. The second entity 225 can set the maximum number and the type and neighborhood for property acquisitions in order to assist in defining the project 235. The first entity 220 is typically responsible for all losses but is entitled to only 75% of gains.

The second entity 225 can agree, in exchange for the benefits provided by the first entity 220, assign and transfer the benefits of the ownership of the project 235 (for example, appreciation, net income, depreciation, tax benefits, equity, debt reduction, disposition proceeds, refinance proceeds). The second entity 225 can assign all rights and responsibilities associated with the operation and management of each subject property 200 to the third entity 245 which could operate their business affairs. The third entity 245 interest can be owned as follows: the first entity 75% and the second entity 25%. The second entity 225 can lend to the first entity 220 all loan proceeds obtained in the event of refinance of all or part of the project 235. Such proceeds are to be repaid to the second entity 225 through the repayment of the mortgage(s) 224 on the project 235 over the course of the mortgage loans.

In order to secure its 75% ownership stake in the project 235, the second entity 225 shall grant the first entity 220 a lien on the subject property equal to 75% of the equity project 235 at the time of partial project 235 refinancing thereby defining the seventy-five lien 226. The seventy-five lien 226 can typically take the form of an interest bearing lien that at a rate set by the first entity 220 intended to equal to 75% of the average annual rate of appreciation in the relevant market. The first entity 220 may remove the seventy-five lien 226 at either the refinancing or disposition of the property. If part or all of the project 235 is sold then all net proceeds of sale, after payment of all loans, but not the seventy-five lien 226, be distributed on a percentage of ownership basis as set forth in the contractual agreements 230. The seventy-five lien 226 can also be arranged between the first entity 220 and the second entity 225 by both parties executing a pair of promissory notes.

A first promissory note (e.g., 218) is typically implemented when the first entity 220 supplies capital to a property owner (not shown) in order to acquire and possibly rehabilitate the property 200 while title (not shown) of the property 200 is transferred to the second entity 225. A second promissory note (e.g., aspect of the seventy-five lien 226) can then be executed after the second entity 225 obtains a mortgage from a lender and provides the first entity 220 with capital from the loan in order to pay back on the first promissory note 218. A third promissory note (e.g., another aspect of the seventy-five lien 226) loan can then be executed to assure that the first entity 220 assume the obligation to repay the mortgage lender on behalf of the first entity 220.

The first entity's 220 responsibilities to the second entity 225 can include agreeing to identify, negotiate acquisition price and terms, assist in property transfer to the second entity 225, rehabilitate, and stabilize residential real property with the intention of operating such property as long term rental housing. The first entity 220 agreeing to locate lending institutions who will provide desirable long-term mortgage financing on subject property at desirable terms. The first entity 220 agreeing to locate title agencies and closing/escrow agents who will provide the necessary services at favorable terms. The first entity 220 agreeing to locate insurance companies who will provide the necessary property insurance at favorable terms. The first entity 220, with its own capital, agreeing to fund all necessary processes to prepare property for refinance process. The first entity 220 agreeing to provide the second entity 225 with timely financial reporting in reference to subject property 200.

The first entity 220 responsibilities can also include guaranteeing to make all required mortgage payments as required per the loan agreement between the second entity 225 and lender. The first entity 220 guaranteeing to make all necessary repairs and improvements, deal with all government entities and perform on behalf of the second entity 225 any and all other financial obligations associated with the ownership of subject property. The first entity 220 guaranteeing to indemnify the second entity 225 from any and all liability costs and expenses and/or litigation resulting from ownership of subject property. The first entity 220 agreeing to make payment for any and all operating losses that may occur during the ownership of subject property. The first entity 220 agreeing, in an attempt to provide for the second entity 225 additional security, to set up a separate joint account with the second entity 225 and fund such account with an amount equal to six months of mortgage payments. Such account will be accessible by both parties and the second entity 225 will have the option of using the proceeds in the account to make a mortgage payment if no payment has been made by the twentieth of the month. The account will exist for five year from the date of the refinancing. Thereafter, the first entity 220 shall be permitted to liquidate the account and repay any funds owing to the first entity 220 by the project 235. A substantial portion of the first entity's 220 responsibilities as just described can be accomplished by using the property acquisition and credit investment management system 126.

The second entity's 225 responsibilities to the first entity 220 or third entity 245 can include agreeing to provide the first entity 220 with all the documentation required by lenders in order to secure mortgage financing on subject property 200 including current pay stubs, last two years' tax returns, last two months' of asset statements, listing of assets and liabilities, permission to secure current credit report, and any other documentation that lending entity providing the mortgage may require. The second entity 225 agreeing to update the first entity 220 on monthly basis when requested by the first entity 220 with the required loan documentation during the second entity's acquisition period. The second entity 225 agreeing that it will be the responsibility of the second entity 225 to determine how the gains or losses generated in the third entity 245 are to be applied to the second entity's particular financial situation. The second entity 225 agreeing to execute a power of attorney 228. Among other uses, the power of attorney agreement 228 may be used to execute all of the notes and mortgages referenced in the agreement 230. Cooperating with the first entity 220 at the expense of the second entity 225, in the event the second entity 225 is required to sign or to appear on behalf of the project 235.

FIG. 2e is a flowchart illustrating the steps of a method for acquiring and encumbering a property in accordance with the invention. A property having investment components 200 including a credit investment component and at least one of a capital investment component, a knowledge investment component, and a labor investment component can be acquired in step 250. After the property 200 is acquired (step 250), the property can then be encumbered in step 255 with a contractual agreement 230 between the first entity 220 and the second entity 225 wherein the second entity 225 agrees to provide the credit investment component 210 and the first entity 220 agrees to provide at least one of the remaining investment components (e.g., 202, 204, 206, 208).

FIG. 2f is a flowchart illustrating the steps of a method for executing an agreement relating to a property in accordance with the invention. A contractual agreement 230 is executed in step 260 between the first entity 220 and the second entity 225. The first entity 220 supplies in step 265 a first amount of capital to a property owner of a property 200 either directly or via the second entity 225 in exchange for transferring title of the property 200 to the second entity 225 having a loan obtainment ability in accordance with the agreement 230. The second entity 225 can then obtain a loan in step 270 for a second amount of capital from a lender by using the property 200 as collateral wherein the loan includes a loan obligation to repay the lender in accordance with the agreement. The second entity 225 can then transfer in step 275 at least a portion of the second amount of capital to the first entity 220 in accordance with the agreement 230. The first entity 220 can then repay the lender in step 280 in accordance with the agreement 230.

For example, when a first entity 220 identifies a suitable property, the first entity 220 shall give the second entity 225 a non-recourse, interest free loan 218 in the amount of the purchase price of the property 200 and all other costs related to the purchase of the property. This loan shall be reflected in the form of a promissory note (e.g., 218) secured by a mortgage 224 on the property 200 being purchased. Contemporaneous to the property 200 being transferred to the second entity 225, the second entity 225 shall grant a leasehold interest such as a master lease agreement 221 in the property 200 or properties to first entity 220. The term of the lease shall be one year more than a selected time horizon 234. The second entity 225 agrees that once first entity 220 performs all of the necessary improvements to the property 200 or properties, the second entity 225 will refinance the property 200 for 75% to 80% (e.g., seventy-five lien 226) of the post renovation fair market value of the property 200 and loan the entire net proceeds from the refinance to the first entity 220. In order to secure the obligation of the second entity 225 to loan the proceeds from the refinance to first entity 220, the second entity 225 shall be granted a mortgage 224 in the property 200 or properties. The combined amount of both the mortgages will be approximately 75% to 80% of the post renovation fair market value of the property. The loan by second entity 225 to first entity 220 from the proceeds from the refinance shall be reflected in a promissory note. Both of these mortgages 224 shall be paid off and subsequently cancelled by the proceeds from the refinance.

FIG. 2g is a flowchart illustrating the steps of a method for executing additional agreements relating to a property in accordance with the invention. When the property 200 is acquired in step 285 in accordance with the contractual agreement 230, the property 200 can then be encumbered in step 290 with a non-recourse promissory note 218 until the second entity 225 transfers at least a portion of the second amount of capital to the first entity 200 in accordance with the agreement 230. The property 200 can then be encumbered in step 295 with a master lease agreement 221 after the second entity 225 transfers at least a portion of the second amount of capital to the first entity 220 in accordance with the agreement 230.

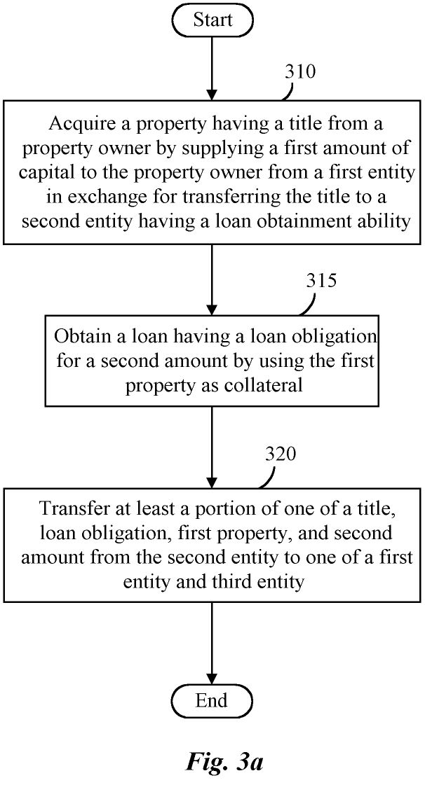

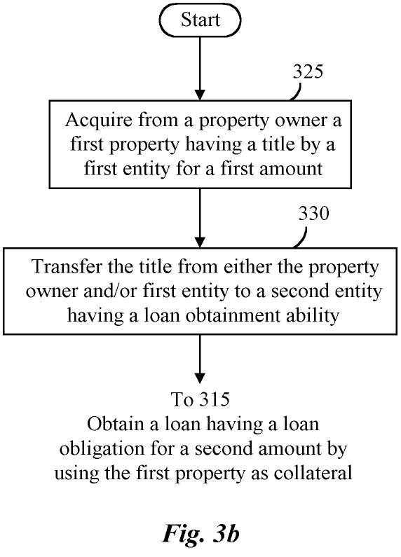

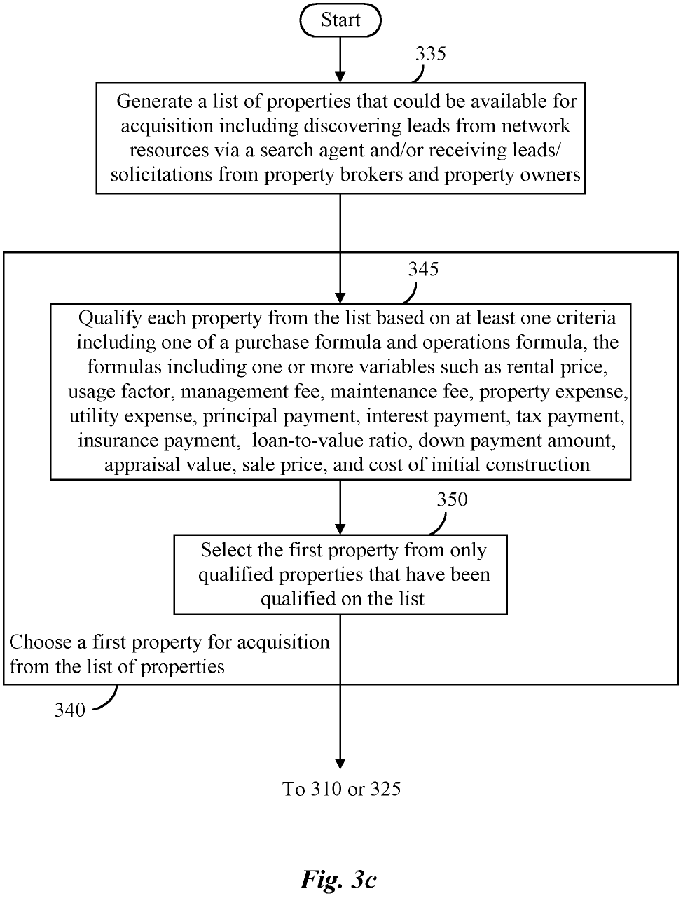

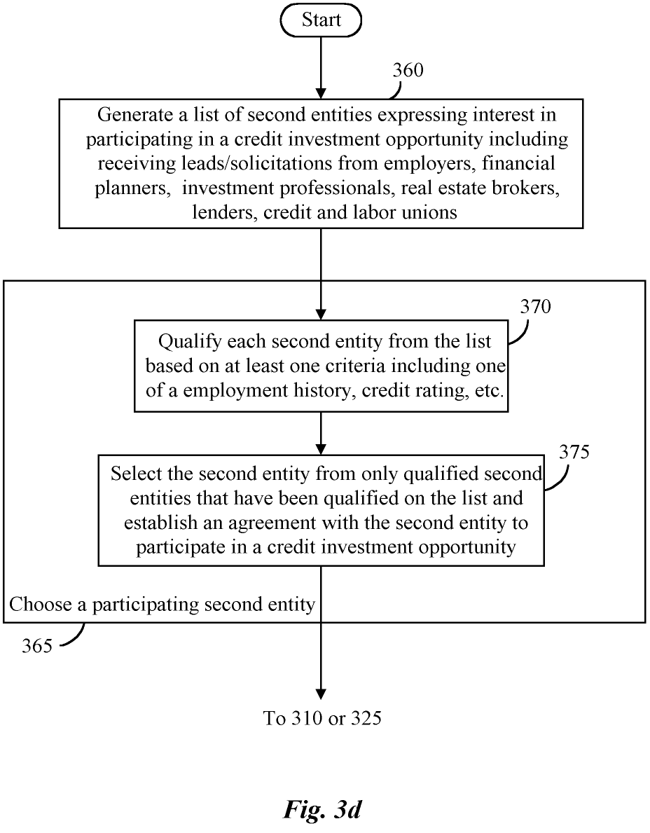

FIG. 3a is a top-level flowchart illustrating the steps of a method for acquiring a property in accordance with the invention. A property having a title can be acquired in step 310 from a property owner by supplying a first amount of capital to the property owner from a first entity 220 in exchange for transferring the title to a second entity 225 having a loan obtainment ability. The second entity 225 can then obtain a loan in step 315, the loan having a loan obligation for a second amount by using the first property as collateral. After the loan is obtained (step 315), the second entity 225 can then transfer in step 320 at least a portion of at least one of a title, loan obligation, first property, and second amount from the second entity 225 to at least one of a first entity 220 and third entity 245 where the third entity 245 is owned by both the first entity 220 and second entity 225.

FIG. 3b is a flowchart illustrating the steps of a method for transferring a property title in accordance with the invention. A first entity 220 can acquire in step 325 from a property owner for a first amount, a first property having a title. The title can then be transferred in step 330 from the first entity 220 to a second entity 225 having a loan obtainment ability. The second entity 225 can then obtain a loan in step 315, the loan having a loan obligation for a second amount by using the first property as collateral.

For example, the first entity 220 can buy and rent out small residential properties with the intention of capitalizing on the benefits associated with the ownership of these properties over the long term. In order to obtain optimized financing terms, the first entity 220 can form an equity partnership with a second entity 225 to enable individuals who are capable of qualifying for and obtaining mortgages 224 secured by these investment properties.

In exchange for the credit obtainment ability of the second entity, such an equity partner can receive a percentage ownership interest in every property in which the second entity 225 participates in obtaining a mortgage 224. This interest is an equity position in the property which entitles the second entity 225 or equity partner to a percentage of all net income, of any proceeds derived from a sale or refinance of the property, of all the tax benefits associated with the ownership of the investment, and of all the equity in the property.

FIG. 3c is a flowchart illustrating the steps performed for choosing a property for acquisition from a list of properties in accordance with the invention. A list of properties that could be available for acquisition can be generated in step 335 by discovering leads from network resources via a search agent and/or receiving leads/solicitations from property brokers and property owners. A first property can be chosen for acquisition in step 340 from the list of properties. More specific steps for choosing the property can include qualifying each property in step 345 from the list based on at least one criteria including at least one of a purchase formula and operations formula, the formulas including one or more variables such as rental price, usage factor, management fee, maintenance fee, property expense, utility expense, principal payment, interest payment, tax payment, insurance payment, loan-to-value ratio, down payment amount, appraisal value, sale price, and cost of initial construction. After qualification (step 345), the first property can be selected in step 350 from only qualified properties that have been qualified on the list. After selection (step 350), the property having a title can be acquired (step 310) from a property owner by supplying a first amount of capital to the property owner from a first entity 220 in exchange for transferring the title to a second entity 225 having a loan obtainment ability or the first entity 220 can acquire (step 325) from a property owner for a first amount, a first property having a title.

In accordance with a preferred aspect of the invention, when property selection is applied to real estate, it is desirable to identify leveraged financing options for one to four family residential real estate investments. These financing guidelines allow acquisitions to be typically financed at an 80% loan-to-value (LTV), which represents 99-100% of the cost of acquisition and rehabilitation. Because such properties can be consistently acquired at a significant discount to their after repair value (ARV), the 80% LTV of the ARV is equal to 99-100% of the original investment. Unlike larger real estate projects that require a minimum of 20% buyer's equity in the project 235, the increased leverage translates into a significantly higher rate of return. By supplying an average of one percent of a property's purchase price in the transaction with a conservative annual appreciation rate of four percent, the invested capital will yield an annual unrealized rate of return of over 300% from appreciation alone. While a typical real estate commercial transaction requires a 20-25% down payment, the credit investment system can consistently generate profitable transactions where the lender underwrites a mortgage equal to 99-100% of the seller's original purchase price. The reason these lax financing programs are available in the one to four family market is because there exists a liquid secondary market for lenders who originate these loans.

The U.S. Federal Government through its creation of Fannie Mae, purchases these loans from lenders allowing them to replenish their funds to originate more loans. Fannie Mae thus serves the cause of allowing more Americans to become homeowners, the lenders' risk of non-payment is almost non-existent since they pass the risk on to this government entity, and home buyers are able to purchase homes without having to come up with exorbitant sums of money for a down payment. The key is that these Fannie Mae backed loans, and the lax guidelines associated with them, are only available for residential property, a term defined by the lending community as residential property not exceeding four units. It is these properties 200 that are the preferred investment focus of the property investment system 215 and the property acquisition and credit investment management system 126.

FIG. 3d is a flowchart illustrating the steps of a method for choosing a participating second entity in accordance with the invention. A list of second entities expressing interest in participating in a credit investment opportunity can be generated in step 360 by receiving leads/solicitations from employers, financial planners, investment professionals, real estate brokers, lenders, credit and labor unions. A participating second entity 225 can be chosen in step 365 from the list of second entities. More specific steps for choosing the second entity 225 can include qualifying each second entity in step 370 from the list based on at least one criteria including at least one of an employment history, credit rating, etc. After qualification (step 370), the second entity 225 can be selected in step 375 from only qualified second entities that have been qualified on the list and a contractual agreement 230 can be established with the second entity 225 to participate in a credit investment opportunity. After selection (step 375), the property having a title can be acquired (step 310) from a property owner by supplying a first amount of capital to the property owner from a first entity 220 in exchange for transferring the title to a second entity 225 having a loan obtainment ability or the first entity 220 can acquire (step 325) from a property owner for a first amount, a first property having a title.

In exchange for using one's credit obtainment ability, the second entity 225 or rather equity partner can receive a 25% ownership interest in each property in which they participate in to obtain a mortgage, for example. This interest is an equity position in the property which entitles the equity partner to 25% of all net income, 25% of any proceeds derived from a sale or refinance of the property, 25% of all the tax benefits associated with the ownership of the investment, and 25% of all the equity in the property. The first entity 220 guarantees to operate the properties, provide timely and detailed accounting to the equity partner, and fund all of any short term shortages that any given property may incur at any given time.

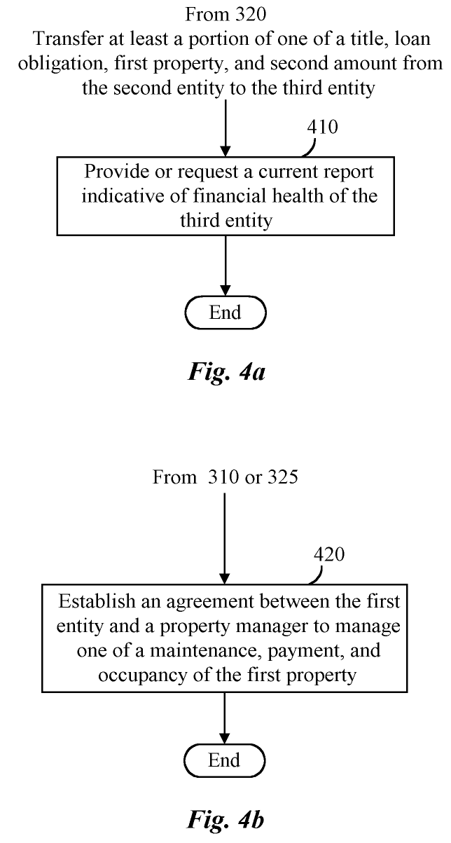

FIG. 4a is a flowchart illustrating the steps of a method for requesting a current report indicative of financial health of a third entity in accordance with the invention. When at least a portion of at least one of a title, loan obligation, first property, and second amount is transferred (step 320) from the second entity 225 to at least one of a first entity 220 and third entity 245, a current report indicative of financial health of the property investment or third entity 245 can then be provided and/or requested in step 410.

FIG. 4b is a flowchart illustrating the steps of a method for establishing an agreement between a first entity and a property manager to manage at least one property in accordance with the invention. When the property having a title is acquired (step 310) from a property owner by supplying a first amount of capital to the property owner from a first entity 220 in exchange for transferring the title to a second entity 225 having a loan obtainment ability or the first entity 220 acquires (step 325) from a property owner for a first amount, a first property having a title, an agreement can be established in step 420 between the first entity 220 and a property manager to manage at least one of a maintenance, payment, and occupancy of the acquired first property.

When title is transferred, the investment becomes a traditional residential real estate acquisition requiring traditional residential real estate management. All management responsibilities will be contracted to locally managed participating property management entities. A monthly fee of 8.5% of collected monthly gross income will be paid to the management firm in exchange for their services and compliance of all contractual obligations. Duties can include collecting rents, enforcing rental policies, tenant relations, all administrative tasks such as local government interaction and bill paying, and hiring contractors for all maintenance/improvement related tasks. The management entities will additionally perform all leasing duties in exchange for 50% of first month's rent not to exceed $300 per unit, for example. If the management entity is responsible to oversee the cost of the preliminary rehabilitation of the property, the management entity will receive a 10% surcharge of the total cost of labor and material required to bring the property into rent ready condition.

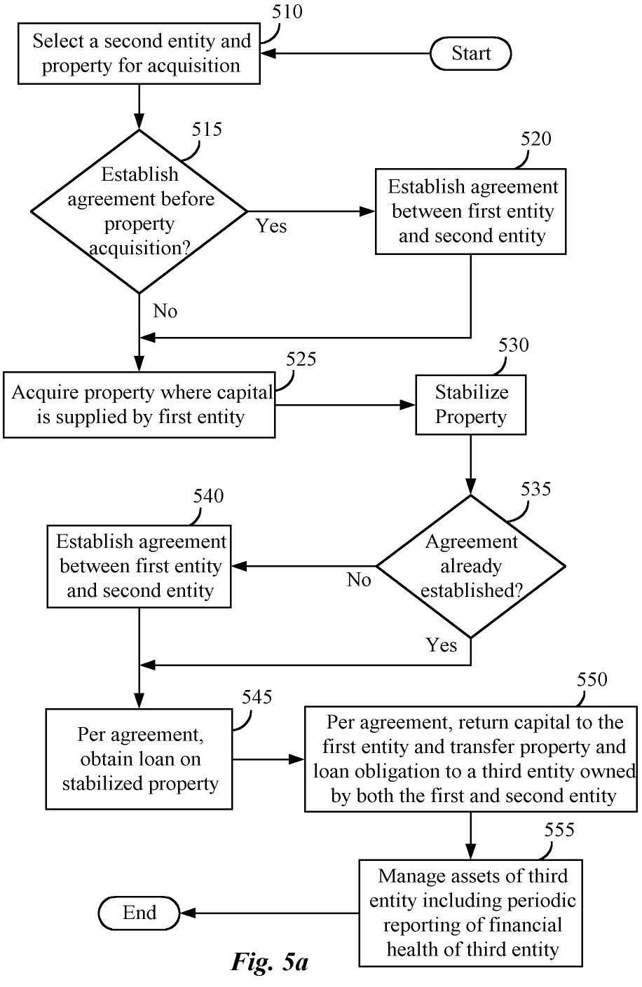

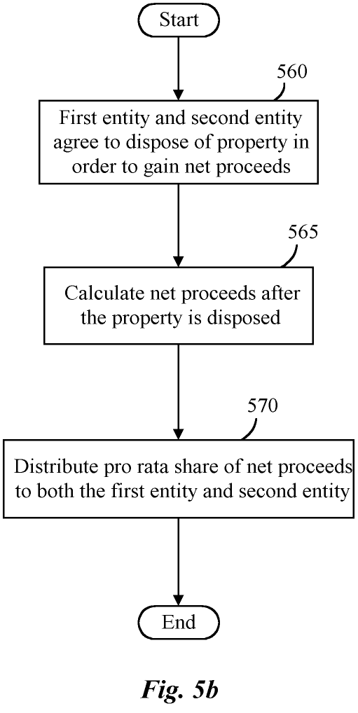

FIG. 5a is a flowchart illustrating the steps of a method for investing in a property in accordance with the invention. When a second entity 225 is chosen and a property for acquisition is selected in step 510, it can be determined in step 515 whether a contractual agreement 230 is to be established between a first entity 220 and a second entity 225 before the acquisition of the selected property. If so, then an agreement between first entity 220 and second entity 225 is established in step 520. Either when an agreement is established (step 520) or determined to be not established as of yet (step 515), the property can be acquired in step 525 with capital supplied by the first entity 220. The acquired property usually in a state of distress can then be stabilized in step 530. A contractual agreement 230 between first entity 220 and second entity 225 can be established in step 540 when it is determined in step 535 that the contractual agreement 230 has not yet been established between the first entity 220 and the second entity 225. A loan can then be obtained in step 545 on the stabilized property in the name of the second entity 225 as specified in the agreement 230. The second entity 225 can then return capital in step 550 to the first entity 220 and transfer the property and loan obligation into a third entity 245 owned by both the first and second entity. Assets of the third entity 245 can then be managed in step 555 including the periodic reporting of the financial health of the third entity 245.

In one aspect of the invention, all subject properties can be purchased for cash using a pre-established revolving commercial line of credit. Upon completion of the purchase and rehabilitation of the subject property, the properties can be refinanced at 75-80% LTV through a participating credit investor. The acquisition strategy takes advantage of the disparity between the sales price and the subject property's appraised value. This disparity allows for refinancing at 75-80% LTV against the property's appraised value. The transaction flows as following: A favorable purchase price of $40,000 cash for a subject property that requires an additional investment for improvements can be negotiated. After investing an additional $12,000 in improvements and allocating $3,000 to closing costs and holding time, a total investment of $55,000 is realized. Concurrently, at the time of purchase, the process of refinancing the property begins. An appraisal value is obtained subject to an identified list of improvements to perform upon the subject property. Based on these improvements and renovations, an appraised value of $75,000 is realized. Upon completion of the renovation project 235, a fixed rate 30 year mortgage on the property at 75-80% LTV can be obtained through the participation of the qualifier (depending on the qualifier's credit score) of the $75,000 appraised value. The following outline illustrates the transaction flow:

Purchase Price $40,000

Closing Costs (Buy) $750

Repairs $12,000

Closing Costs (Refi) $2,000

Carrying Costs $250

Total Initial Investment $55,000

LESS:

Refinance Proceeds $56,250 (75% LTV)

Total Final Investment ($1,250) (Operating Reserve)

TOTAL FUNDS INVESTED $0

In this example a $75,000 appreciating asset is controlled with a post stabilization investment of $0 and an operations reserve of $1,250. Such numbers will obviously vary from property to property resulting in anything from a $0 investment with an additional operations reserve to up to a 1% investment. A typical cycle to purchase the property, complete the improvements, and obtain the permanent financing will take 45-60 days depending upon the extent of the improvements.

This purchasing formula can be scaled with each metropolitan market. For instance, the following quantitative criteria must be met by a subject property to qualify for purchase in the Cuyahoga County area of Ohio during 2002, for example. The property must be purchased and prepared for rent ready condition on average for no more than approximately 75% of its potentially appraised value. The down payment investment+closing costs+project development fees must not exceed, on average, the refinance amount. The following (SAMPLE) post stabilization operational formula is to be concurrently adhered to in the selection of property:

Potential Monthly Gross Rents

×0.92 (8% vacancy factor)

×0.915 (8.5% management fees)

−$100/unit (monthly expense/reserve)

−PITI>$50 (monthly principal, interest, taxes, insurance)

The criteria examined and the analysis performed to determine whether a subject property qualifies for purchase under such guidelines is strictly quantitative. The assumptions made under the above criteria are the appraisal of the subject property can be reasonably predicted, the cost of the repairs and improvements can be accurately determined, monthly gross rents can be accurately predicted, the vacancy factor will not exceed 8%, the average monthly per unit expense will not exceed $100, and monthly PITI can be accurately predicted.

With the aid of various real estate related subscription based databases operatively coupled to the property acquisition system 126, the appraisal of the subject property can be reasonably predicted. It can be known prior to making an offer whether comparable sales exist to support the appraised value. If comparable sales do not exist, and other compensating factors for a higher value (such as type of construction, condition, newer improvements) can not be verified, the subject property 200 most probably will not be selected from the list of properties.

FIG. 5b is a flowchart illustrating the steps of a method for disposing of a property in accordance with the invention. The first entity 220 and the second entity 225 both agree in step 560 to dispose of the property 200. Net proceeds are then calculated in step 565 after the property 200 is disposed. The pro rata share of the net proceeds are then distributed in step 570 to both the first entity 220 and the second entity 225 in accordance with the property investment instrument 230.

When property investment instrument 230 is created, the second entity 225 can select from a plurality of ownership interest types 236 in the property 200. The interest types can include a net option 237, a blended option 238, and a gross option 239. When the net option 237 is selected the second entity 225 can be entitled to a percentage of the annual net rent proceeds, as determined by first entity 220, and a percentage of the net proceeds from the disposition of the property 200. When the blended option 238 is selected, the second entity 225 can be entitled to 1% annual gross rent proceeds and 10% of the annual net rent proceeds, as determined by first entity 220, and 10% of the net proceeds from the disposition of the property. When the gross option 239 is selected, the second entity 225 can be entitled to 2% of the annual gross rent proceeds, as determined by first entity 220, and not receive any proceeds from the disposition of the property.

Net proceeds from the disposition of the property is defined as the second entity's 225 percentage of the net proceeds from the sale of the property. If the disposition of the property is not a sale but involves paying the second entity 225 their percentage from the proceeds of a refinance or directly from first entity's 220 funds, then second entity 225 shall receive an amount equal to their percentage of the net proceeds had the property 200 been sold at the appraised amount. In reference to the blended option 238 and gross option 239, the percentage of annual gross rent proceeds shall increase by ½% on all properties in the project 235 every five years and by ¼% on all properties in the project 235 with the completion of the refinance on each additional property.

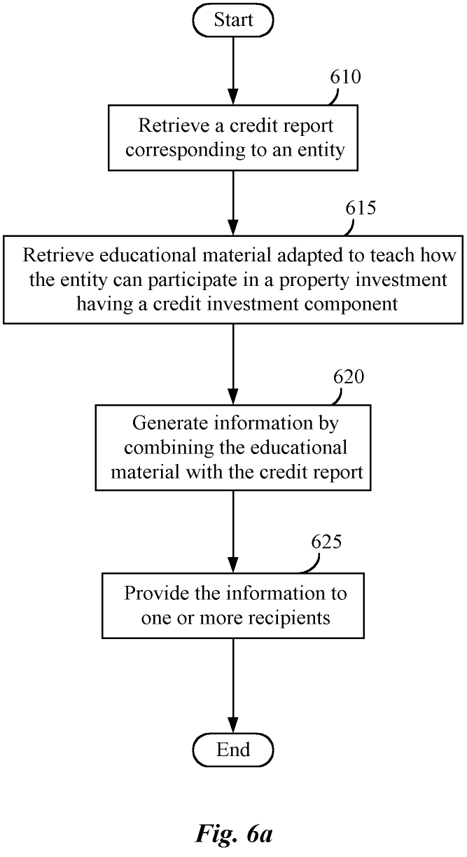

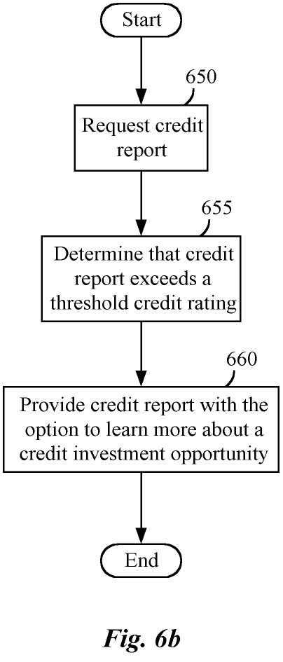

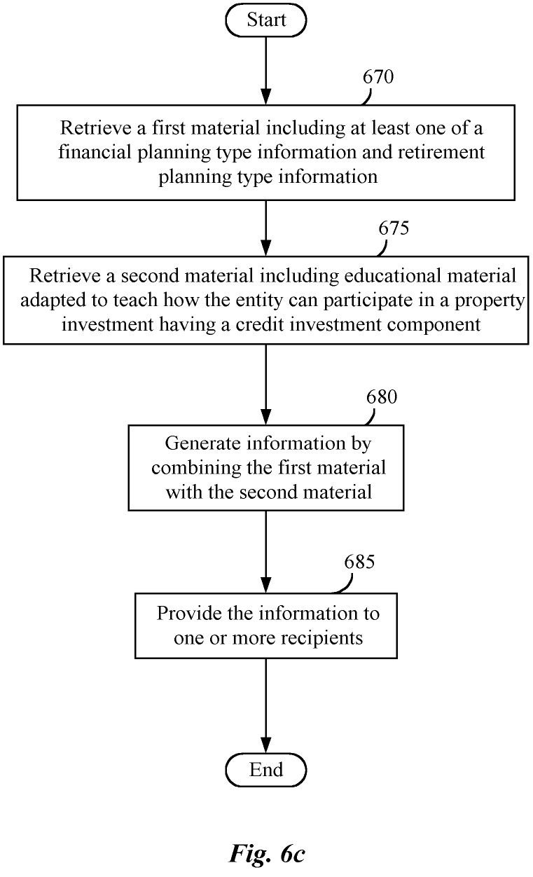

FIG. 6a is a flowchart illustrating the steps of a method for learning about a credit investment opportunity in accordance with the invention. When a credit report corresponding to an entity is retrieved in step 610, educational material adapted to teach how the entity can participate in a property investment system 215 having a credit investment component can also be retrieved in step 615. Information can then be generated in step 620 by combining the educational material with the credit report. Such generated information can then be provided in step 625 to one or more recipients such as the entity, a representative of such entity, or any requester of such information.

FIG. 6b is a flowchart illustrating the steps of a method for requesting a credit report in accordance with the invention. Whenever a credit report is requested by a requestor in step 650 and it is determined in step 655 that the credit report exceeds a threshold credit rating, the requestor can be provided the credit report in step 660 with the option to learn more about a credit investment opportunity. The credit report can be requested across any communication network such as a PSTN, cellular network, and Internet. In some cases, representatives of either the requester or the credit reporting service that access the credit report can serve the role of determining whether a threshold value has been exceeded. Presenting the credit investment opportunity in response to accessing the credit report, enables better target marketing of potential credit investors. Management affiliates and service professionals can serve as distributors to a new kind of credit investment community.

Another method for learning about a credit investment opportunity can similarly be accomplished with respect to combining educational material (see FIG. 6a) with other information sources. For instance, whenever materials relating to any type of a financial related plan such as tax information, stock market information, employee stock options, bonds, mutual funds, and the like or retirement related plan such as a pension plan, profit-sharing plan, 401(k), 403(b), 404(c), or 412(i) plan, ESOP plan, Roth plan, Keough plan, or Individual Retirement Account (IRA) is presented to an individual, representative of an individual, or group of individuals by a service professional such as a financial planner or a representative of a human resources department of an employer, such financial and retirement type materials can be combined with educational material adapted to teach how the entity, employee, or representative of the entity can participate in a property investment system 215 having a credit investment component 210 so that such combination of materials becomes information of further use to one or more recipients of such materials.

FIG. 6c is a flowchart illustrating the steps of a method for providing generated information to one or more recipients in accordance with the invention. When a first material including at least one of a financial planning type information and retirement planning type information is retrieved in step 670, a second material including educational material adapted to teach how an entity can participate in a property investment system 215 having a credit investment component 210 can also be retrieved in step 675. An information package can then be generated in step 680 by combining the first material with the second material. Such a generated information package can then be provided by a provider in step 685 to one or more recipients. Such a provider can include institutions and professionals such as human resources department, an employer, a stock analyst, a tax consultant, an accountant, a financial services provider, a financial planner, a retirement planner, a banker, a stock broker, an insurance agent, and a real estate associate.

By choosing to become a credit investor, an individual having a modest income can create a supplemental retirement plan that works concurrently with a 401k or IRA. Marketing and education is an important component in the recruitment of credit investors. The ability to participate in the benefits of real estate ownership without the investment of time or money is novel. Without having to learn about the local real estate market, without having to worry about the day to day management, and without having to reallocate and risk any investment dollars, participants will be able to partake in the appreciation of value, the net operating income, the tax benefits, and the equity buildup that these properties offer.

A common means for a credit investor (e.g., second entity 225) to participate in a property investment opportunity could be through their employer. The first entity 220 can market the credit investment management system directly to employers to offer the plan as part of an employee benefits package. This strategy can in turn assist the employer in being able to attract and retain quality employees by this unique offering.

FIG. 7a is a block diagram illustrating an exemplary property acquisition and credit investment management system in accordance with the invention. As mentioned, the property acquisition and credit investment management system 126 is preferably implemented as a web-based portal system that can be accessed and used by property owners, property managers, credit investors, equity partners, and the like via the Internet 130. The system 126 can be programmed according to many different programming models and languages. Multiple graphical user interfaces 128 of the system 126 are programmed using known web-based programming languages and tools, such as HTML, XML, Java, Javascript, etc. The property acquisition and credit investment management system 126 includes an entry portal 702, which is the typical starting point for interfacing with other main user interface modules. Such main user interfaces 128 can include a credit investor interface 704, a capital investor interface 706, and a property acquisition and management interface 708. Each of these interface modules are in operative association to a system database 710. The are many more interfaces that communicate with the system database 710 as will be discussed in conjunction with FIG. 8. The system database 710 is structured so that each user has complete access to the appropriate data records of interest including the option of setting filters to improve querying and limiting access by other system users.

The system data stored in the system database 710 primarily comprises information and input by various users accessing the system 126 from other main systems via the Internet 130. Such primary computer systems can include a credit investor system 714, a capital investor system 716, and a property acquisition and management system 718. Various users of each main system enters the property acquisition and credit investment management system 126 through the entry portal 702 and is then directed to the appropriate user interface module depending upon the type of user by verifying the user's identity by querying for a username and password. Entry can however be configured to be accomplished automatically by reading information such as a “cookie” stored locally on a user's computer.

FIG. 7b is a block diagram illustrating an exemplary property acquisition and management system in accordance with the invention. The property acquisition and credit investment management system 126 can further be in operative communication with many other computer systems and/or devices including a property management affiliate system 720, a property appraisal system 725, a property insurance system 730, a company human resource system 735, a property broker system 740, a property seller system 745, a monitoring and reporting system 750, a title and escrow system 755, property ownership system 760, and a capital lender system 765. Each system can be software driven. For instance, a general purpose computing device can be configured by software to perform at least a portion of a distributed property acquisition and credit investment system 126. As will be shown, (see FIG. 8), each aspect of the property investment system 215 can be accessed from specialized user interfaces, any of which can be implemented from a single computing machine and/or a distributed network of computing machines.

FIG. 7c is a block diagram illustrating an exemplary property management affiliate system in accordance with the invention. The property management affiliate system 720 can further be in operative communication with many other computer systems and/or devices including the property acquisition and credit investment management system 126, property supplier system 770, a housing authority system 775, a contractor/vendor system 780, a property maintenance system 785, and a tenant system 790.

FIG. 8 is a block diagram illustrating exemplary related system user interfaces in accordance with the invention. There are many additional user interfaces 128 that can be operative communication with the system database 710 including a property acquisition interface 810, an equity management/property ownership interface 815, a capital lender interface 820, a tenant interface 825, a housing authority interface 830, a property maintenance interface 835, a property management affiliate interface 840, a contractor interface 845, a supplier interface 850, a property appraisal interface 855, a property insurance interface 860, a human resource interface 865, a property broker interface 870, a property seller interface 875, a monitoring and reporting interface 880, and a title and escrow interface 885.

Other aspects of the invention include executing at least one contractual agreement before the first entity obtains the first amount of capital for the owner of the property and where at least one of an obtaining the first amount of capital, transferring the title of the property to the second entity, obtaining the loan for the second amount of capital from the lender by using the property as collateral, and transferring the at least a portion of the second amount of capital to the first entity is performed in accordance with the at least one contractual agreement. At least one of a first entity and second entity can be capable of accessing a current report indicative of financial health of at least one of a third entity and property investment.

The first entity can provide the first amount of capital to the second entity and the second entity can provide the first amount of capital to the owner of the property in exchange for transferring title of the property to the second entity. The property can be encumbered with a non-recourse promissory note until the second entity transfers at least a portion of the second amount of capital to the first entity. The property can be encumbered with a master lease agreement after the second entity transfers at least a portion of the second amount of capital to the first entity and until repaying the lender.

The second amount of capital is greater than or equal to the first amount of capital. The first entity can acquire more properties with at least a portion of the second amount of capital received from the second entity. The owner of a property can indicate to the first entity that the property could be available for acquisition. The property can be chosen for acquisition from a plurality of properties. The property is chosen by at least one of a first entity, second entity, and property broker.

The property can be qualified based on at least one criteria such as at least one of a loan-to-value ratio, down payment amount, appraisal value, sale price, purchasing formula, and operational formula. The purchasing formula can include comparing a total initial investment needed for at least one of an acquiring the property and restoring the property in relation to refinancing the property for an appraised value after acquiring the property. The total initial investment can be an amount of capital less than or equal to the second amount of capital. Management of the property can include establishing an agreement between the first entity and a property manager to manage at least one of a maintenance, payment, and occupancy of the property. Each property can be disposed of in such a manner as to allow at least one of a first entity, second entity, third entity or any other participating entities to realize a return on the property investment instrument.

The property investment instrument having at least one contractual agreement can also include a selection of project parameters adapted to allow the second entity to select at least one of a number of properties, an investment period, and a type of ownership interest including a net option, a blended option, and a gross option.

Although the invention has been shown and described with respect to a certain preferred aspect or aspects, it is obvious that equivalent alterations and modifications will occur to others skilled in the art upon the reading and understanding of this specification and the annexed drawings. In particular regard to the various functions performed by the above described items referred to by numerals (components, assemblies, devices, compositions, etc.), the terms (including a reference to a “means”) used to describe such items are intended to correspond, unless otherwise indicated, to any item which performs the specified function of the described item (e.g., that is functionally equivalent), even though not structurally equivalent to the disclosed structure which performs the function in the herein illustrated exemplary aspect or aspects of the invention. In addition, while a particular feature of the invention may have been described above with respect to only one of several illustrated aspects, such feature may be combined with one or more other features of the other aspects, as may be desired and advantageous for any given or particular application.

The description herein with reference to the figures will be understood to describe the invention in sufficient detail to enable one skilled in the art to utilize the invention in a variety of applications and devices. It will be readily apparent that various changes and modifications could be made therein without departing from the spirit and scope of the invention as defined in the following claims.

What is claimed is:

1. A property investment instrument for investing in one or more properties, the property investment instrument comprising: at least one contractual agreement between a first entity and a second entity to share in said one or more properties, said one or more properties having a plurality of investment components including a credit investment component and at least one of a capital investment component, knowledge investment component, time investment component, and labor investment component wherein said second entity provides said credit investment component and said first entity provides at least one of the remaining components of said plurality of investment components.

2. The property investment instrument, as set forth in claim 1, wherein said at least one contractual agreement includes at least one of a promissory note, an equity partner agreement, a master lease agreement, an open-end commercial mortgage, and a power of attorney agreement.

3. The property investment instrument, as set forth in claim 1, wherein said at least one contractual agreement includes a selection of project parameters, said selection of project parameters adapted to allow said second entity to select at least one of a number of properties, an investment period, and a type of ownership interest.

4. The property investment instrument, as set forth in claim 3, wherein said type of ownership interest includes one of a net option, a blended option, and a gross option.

5. A method for creating a property investment instrument, the method comprising: acquiring one or more properties having a plurality of investment components including a credit investment component and at least one of a capital investment component, knowledge investment component, time investment component, and labor investment component; and, encumbering said one or more properties with at least one contractual agreement between a first entity and a second entity wherein said second entity agrees to provide the credit investment component and said first entity agrees to provide at least one of the remaining components of the plurality of investment components.

6. The method, as set forth in claim 5, wherein said at least one contractual agreement includes at least one of a promissory note, an equity partner agreement, a master lease agreement, an open-end commercial mortgage, and a power of attorney agreement.

7. The method, as set forth in claim 5, wherein said at least one contractual agreement includes a selection of project parameters, said selection of project parameters adapted to allow said second entity to select at least one of a number of properties, an investment period, and a type of ownership interest.

8. The method, as set forth in claim 7, wherein said type of ownership interest includes one of a net option, a blended option, and a gross option.

9. A method for a first entity and a second entity investing in a property comprising: said first entity obtaining a first amount of capital for an owner of said property in exchange for transferring title of said property to said second entity, said second entity having at least one of a loan obtainment ability, mortgage obtainment ability, and credit obtainment ability; said second entity obtaining a loan for a second amount of capital from a lender by using said property as collateral wherein said loan includes a loan obligation to repay said lender; and, said second entity transferring at least a portion of said second amount of capital to said first entity.

10. The method, as set forth in claim 9, further including creating a property investment instrument for investing in said property, said property investment instrument including at least one contractual agreement between said first entity and said second entity.

11. The method, as set forth in claim 10, further including executing said at least one contractual agreement before said first entity obtains said first amount of capital for said owner of said property.

12. The method, as set forth in claim 10, wherein at least one of a obtaining said first amount of capital, transferring said title of said property to said second entity, obtaining said loan for said second amount of capital from said lender by using said property as collateral, and transferring said at least a portion of said second amount of capital to said first entity is performed in accordance with said at least one contractual agreement.

13. The method, as set forth in claim 10, further including at least one of a first entity and second entity requesting a current report indicative of financial health of said property investment.

14. The method, as set forth in claim 9, wherein said first entity said obtaining said first amount of capital for said owner of said property in exchange for said transferring said title of said property to said second entity includes said first entity providing said first amount of capital to said second entity and said second entity providing said first amount of capital to said owner of said property in exchange for said transferring said title of said property to said second entity.

15. The method, as set forth in claim 9, further including encumbering said property with a non-recourse promissory note until said second entity transfers said at least a portion of said second amount of capital to said first entity.

16. The method, as set forth in claim 9, further including said first entity repaying said lender.

17. The method, as set forth in claim 16, further including encumbering said property with a master lease agreement after said second entity transfers said at least a portion of said second amount of capital to said first entity and until said repaying said lender.

18. The method, as set forth in claim 9, wherein said second amount of capital is greater than or equal to said first amount of capital.

19. The method, as set forth in claim 9, wherein said property is a first property and further including said first entity acquiring a second property with at least a portion of said second amount of capital.

20. The method, as set forth in claim 9, further including said owner indicating to said first entity that said property could be available for acquisition.

21. The method, as set forth in claim 9, further including choosing said property for acquisition from a plurality of properties.

22. The method, as set forth in claim 21, wherein said property is chosen by at least one of a first entity, second entity, and property broker.

23. The method, as set forth in claim 21, wherein said choosing said property for acquisition includes qualifying said property based on at least one criteria.

24. The method, as set forth in claim 23, wherein said at least one criteria is at least one of a loan-to-value ratio, down payment amount, appraisal value, sale price, purchasing formula, and operational formula.

25. The method, as set forth in claim 24, wherein said operational formula includes estimating costs on said property for a period, said costs including at least one of a rental price, usage factor, management fee, maintenance fee, property expense, utility expense, principal payment, interest payment, tax payment, and insurance payment.

26. The method, as set forth in claim 24, wherein said purchasing formula includes comparing a total initial investment needed for at least one of an acquiring said property and restoring said property in relation to refinancing said property for an appraised value after acquiring said property.

27. The method, as set forth in claim 24, wherein said total initial investment is an amount of capital less than or equal to said second amount of capital.

28. The method, as set forth in claim 9, wherein said property is a real property and further including rehabilitating said real property.

29. The method, as set forth in claim 9, further including qualifying a loan obtainment ability of said second entity based on at least one loan obtainment criteria.

30. The method, as set forth in claim 29, wherein said at least one loan obtainment criteria includes at least one of a credit score, income, debt, assets, and length of employment.

31. The method, as set forth in claim 9, further including managing said property after said transferring said title of said property to said second entity.

32. The method, as set forth in claim 31, wherein said managing said property includes establishing an agreement between said first entity and a property manager to manage at least one of a maintenance, payment, and occupancy of said property.

33. The method, as set forth in claim 9, wherein said loan is obtained from an originated lender and said loan is at least one of a mortgage, line of credit, and line of equity.

34. The method, as set forth in claim 33, wherein said originated lender can liquidate said loan in a secondary market.

35. The method, as set forth in claim 9, wherein said first entity and said second entity is either an individual or organization.

36. The method, as set forth in claim 35, wherein said organization is at least one of a corporation, partnership, limited liability company, club with membership, union, a group including one or more individuals.

37. The method, as set forth in claim 10, further including disposing of said property in such a manner as to allow at least one of a first entity and second entity to realize a return on said property investment instrument.

38. The method, as set forth in claim 10, wherein said at least one contractual agreement includes at least one of a promissory note, an equity partner agreement, a master lease agreement, an open-end commercial mortgage, and a power of attorney agreement.

39. A method comprising: a first entity acquiring a property from an owner of said property by supplying a first amount of capital to said owner; transferring title of said property to a second entity having a loan obtainment ability; said second entity obtaining a loan for a second amount of capital from a lender by using said property as collateral wherein said loan includes a loan obligation to repay said lender; and, said second entity transferring at least a portion of at least one of a loan obligation, title, property, and second amount of capital to at least one of a first entity and third entity.

40. The method, as set forth in claim 39, wherein said transferring said title to said second entity includes transferring said title to said second entity from at least one of a first entity and owner upon or after acquisition of said property.

41. The method, as set forth in claim 39, wherein said transferring said title to said second entity includes transferring said title to said second entity in exchange for said first entity supplying said first amount of capital to said owner.

42. The method, as set forth in claim 39, further including said first entity minimizing a labor investment of said second entity with respect to at least one of a transferring said title to said second entity, obtaining said loan for said second amount of capital, and transferring at least a portion of at least one of a loan obligation, title, property, and second amount of capital to at least one of a first entity and third entity.

43. The method, as set forth in claim 39, wherein said second amount is greater than or equal to said first amount.

44. The method, as set forth in claim 39, wherein said property is a first property and further including said first entity acquiring a second property with at least a portion of said second amount.

45. The method, as set forth in claim 39, wherein at least a portion of said third entity is owned by said first entity and said second entity.

46. The method, as set forth in claim 39, further including at least one of a first entity and second entity requesting a current report indicative of financial health of said third entity.

47. The method, as set forth in claim 39, further including said owner indicating to said first entity that said property could be available for acquisition.

48. The method, as set forth in claim 39, further including choosing said property for acquisition from a plurality of properties.

49. The method, as set forth in claim 48, wherein said property is chosen by at least one of a first entity, second entity, and property broker.

50. The method, as set forth in claim 48, wherein said choosing said property for acquisition includes qualifying said property based on at least one criteria.

51. The method, as set forth in claim 50, wherein said at least one criteria is at least one of a loan-to-value ratio, down payment amount, appraisal value, sale price, purchasing formula, and operational formula.

52. The method, as set forth in claim 51, wherein said operational formula includes estimating costs on said property for a period, said costs including at least one of a rental price, usage factor, management fee, maintenance fee, property expense, utility expense, principal payment, interest payment, tax payment, and insurance payment.

53. The method, as set forth in claim 51, wherein said purchasing formula includes comparing a total initial investment needed for at least one of an acquiring said property and restoring said property in relation to refinancing said property for an appraised value after acquiring said property.

54. The method, as set forth in claim 53, wherein said total initial investment is an amount less than or equal to said second amount.

55. The method, as set forth in claim 39, wherein said property is a real property and further including rehabilitating said real property either before or after transferring said title to said second entity.

56. The method, as set forth in claim 39, further including establishing at least one contractual agreement between said first entity and said second entity either before or after said first entity acquiring said property.

57. The method, as set forth in claim 56, wherein said at least one contractual agreement includes said first entity agreeing to repay said loan on behalf of said second entity.

58. The method, as set forth in claim 39, further including qualifying a loan obtainment ability of said second entity based on at least one loan obtainment criteria.

59. The method, as set forth in claim 58, wherein said at least one loan obtainment criteria includes at least one of a credit score, income, debt, assets, and length of employment.

60. The method, as set forth in claim 39, further including managing said property after said acquiring said property.

61. The method, as set forth in claim 60, wherein said managing said property includes establishing an agreement between said first entity and a property manager to manage at least one of a maintenance, payment, and occupancy of said property.

62. The method, as set forth in claim 39, wherein said loan is obtained from an originated lender and said loan is at least one of a mortgage, line of credit, and line of equity.

63. The method, as set forth in claim 62, wherein said originated lender can liquidate said loan on a secondary market.

64. The method, as set forth in claim 39, wherein said first entity and said second entity is either an individual or organization.

65. The method, as set forth in claim 64, wherein said organization is at least one of a corporation, partnership, limited liability company, club with membership, union, a group including one or more individuals.

66. The method, as set forth in claim 39, further including disposing of said property in such a manner as to allow at least one of a first entity, second entity, and third entity to realize a return on said property.

67. A method for providing information to one or more recipients comprising: retrieving a credit report corresponding to an entity; retrieving educational material adapted to teach how said entity can participate in a property investment having a plurality of investment components including a credit investment component wherein said entity can participate by agreeing to be responsible for only said credit investment component of said property investment; generating said information by combining said educational material with said credit report corresponding to said entity; and, providing said generated information to said one or more recipients.

68. The method, as set forth in claim 67, wherein said one or more recipients is at least one of an entity and representative of said entity.

69. The method, as set forth in claim 67, further including requesting said credit report corresponding to said entity.

70. The method, as set forth in claim 67, further including determining whether said credit report corresponding to said entity exceeds a threshold credit rating.

71. A method for providing information to one or more recipients comprising: retrieving a first material including at least one of a financial planning type information and retirement planning type information; retrieving a second material including an educational material adapted to teach how an entity can participate in a property investment having a plurality of investment components including a credit investment component wherein said entity can participate by agreeing to be responsible for only said credit investment component of said property investment; generating said information by combining said first material with said second material; and, a provider providing said generated information to said one or more recipients.

72. The method, as set forth in claim 71, wherein said at least one of a financial planning type information and retirement planning type information includes planning type information such as tax information, stocks, employee stock options, bonds, mutual funds, pension plan, profit-sharing plan, 401(k) plan, 403(b) plan, 404(c) plan, 412(i) plan, ESOP plan, Roth plan, Keough plan, and Individual Retirement Account (IRA).

73. The method, as set forth in claim 71, wherein said one or more recipients is at least one of an employee, an entity, and a representative of said entity.

74. The method, as set forth in claim 71, further including requesting said at least one of a financial planning type information and retirement planning type information.

75. The method, as set forth in claim 71, wherein said provider is at least one of a human resources department, an employer, a stock analyst, a tax consultant, an accountant, a financial services provider, a financial planner, a retirement planner, a banker, a stock broker, an insurance agent, and a real estate associate.
